(19) United States
(12) Patent Application Publication
(10) Pub. No.: US 2024/0389107 A1
(43) Pub. Date: Nov. 21, 2024

(54) DETECTION AND HANDLING OF BWP SWITCH FAILURE

(71) Applicant: QUALCOMM Incorporated, San Diego, CA (US)

(72) Inventors: Ling XIE, Beijing (CN); Zhanyi LIU, Beijing (CN); Peng WU, Shanghai (CN); Yicheng SHEN, Shanghai (CN); Tongxin WANG, Shanghai (CN); Qingxin CHEN, San Diego, CA (US); Jun HU, San Diego, CA (US)

(21) Appl. No.: 18/695,791

(22) PCT Filed: Dec. 1, 2021
(86) PCT No.: PCT/CN2021/134804

§ 371 Date: Mar. 26, 2024

(51) Int. Cl. H04W 72/231; H04W 72/0457; H04W 72/1268; H04W 72/40; H04W 74/0833; H04W 76/19

(52) U.S. Cl. CPC H04W 72/231; H04W 72/0457; H04W 72/1268; H04W 72/40; H04W 74/0833; H04W 76/19

(57) ABSTRACT

A first network node (e.g., a UE) may receive, from a second BS network node (e.g., a base station), DCI. The first network node may perform, based on the DCI, a BWP switch from a first BWP to a second BWP. The first network node may perform, after the BWP switch, a BWP switch failure detection procedure that results in a first determination or a second determination. The first determination may be indicative that the BWP switch was successful and the second determination may be indicative that the BWP switch was not successful. To perform the BWP switch failure detection procedure, the first network node may determine whether one or more failure conditions are satisfied. The one or more failure conditions may include at least one of a BLER greater than a threshold, occurrence of one or more tune away events, or non-receipt of an uplink grant on the second BWP.

### CROSS-REFERENCE TO RELATED APPLICATIONS

This application for Patent is a 371 of international Patent Application PCT/CN2021/134804, filed Dec. 1, 2021, which is hereby incorporated by referenced in its entirety and for all purposes.

### TECHNICAL FIELD

The present disclosure relates generally to communication systems, and more particularly, to detection and handling of a bandwidth part (BWP) switch failure in a wireless communication system.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a first network node. The apparatus may receive, from a second network node, downlink control information (DCI). The apparatus may perform, based on the DCI, a BWP switch from a first BWP to a second BWP. The apparatus may perform, after the BWP switch, a BWP switch failure detection procedure that results in a first determination or a second determination. The first determination may be indicative that the BWP switch was successful and the second determination may be indicative that the BWP switch was not successful.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating the operation of a UE in an MSIM mode.

FIG. 5 is a diagram illustrating BWP switch failure detection and handling according to aspects of the disclosure.

FIGS. 6A and 6B are a diagrams illustrating RACH search spaces associated with the first and the second BWPs.

FIG. 7 is a diagram of a communication flow of a method of wireless communication

FIG. 8 is a flowchart of a method of wireless communication.

FIG. 9 is a flowchart of a method of wireless communication.

FIG. 10 is a diagram illustrating an example of a hardware implementation for an example apparatus.

### DETAILED DESCRIPTION

The detailed description set forth below in connection with the drawings describe various configurations and is not intended to represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and use cases are described in this application by illustration to some examples, additional or different aspects, implementations, and use cases may come about in many different arrangements and scenarios. The techniques described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). Implementations may range a spectrum from chip-level or modular components to non-modular, non-chip-level implementations and further to aggregate, distributed, or original equipment manufacturer (OEM) devices or systems incorporating one or more techniques described herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

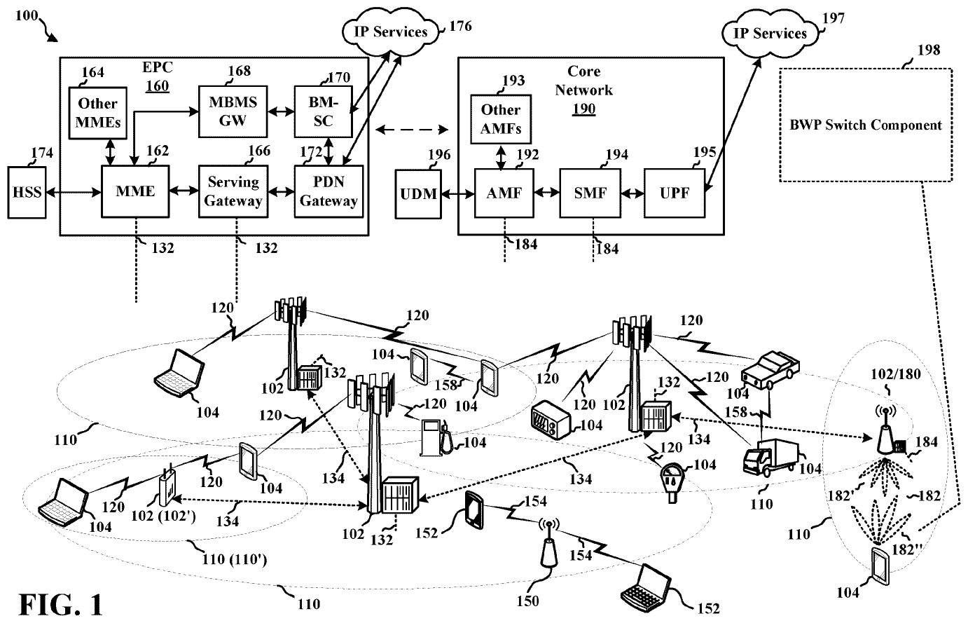

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a BWP switch component 198 that may be configured to receive, from a second network node, DCI. The BWP switch component 198 may be configured to perform, based on the DCI, a BWP switch from a first BWP to a second BWP. The BWP switch component 198 may be configured to perform, after the BWP switch, a BWP switch failure detection procedure that results in a first determination or a second determination. The first determination may be indicative that the BWP switch was successful and the second determination may be indicative that the BWP switch was not successful. Although the following description may be focused on 5G NR, the concepts described herein may be applicable to other similar areas, such as LTE, LTE-A, CDMA, GSM, and other wireless technologies.

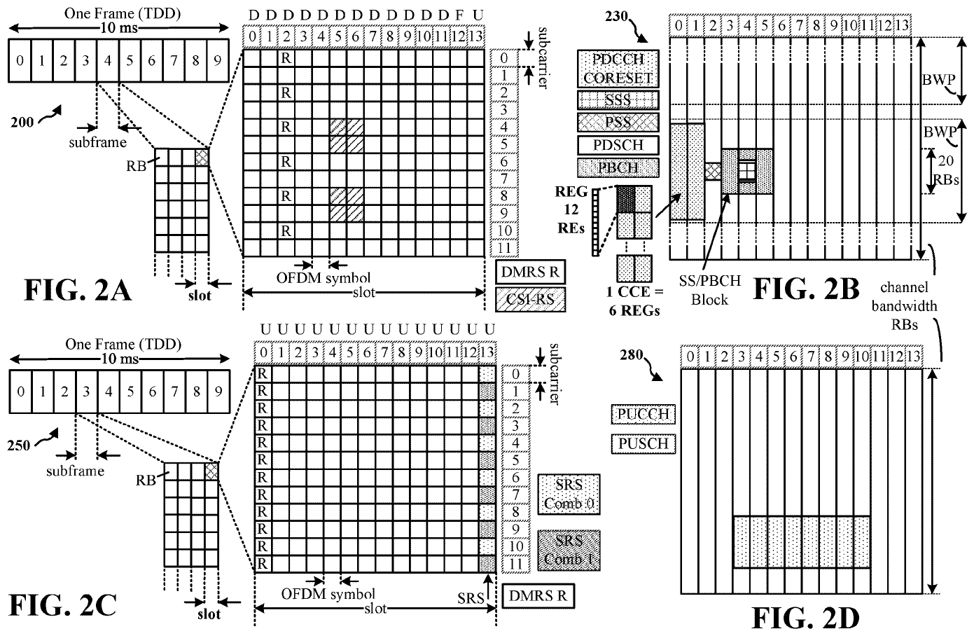

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}* 15 kHz, where μ is the numerology 0 to 4. As such, the numerology μ=0 has a subcarrier spacing of 15 kHz and the numerology μ=4 has a subcarrier spacing of 240 KHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space. UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

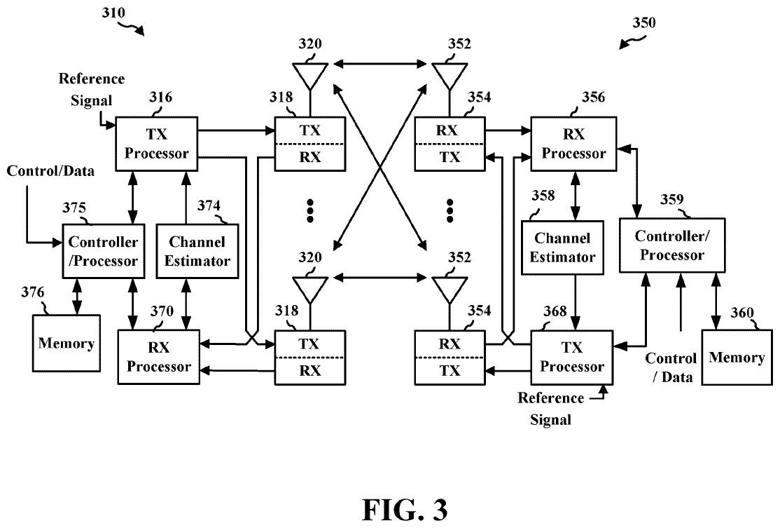

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging. RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization. The transmit (TX) processor 316 and the receive (RX) processor 370) implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

As described herein, a node, which may be referred to as a node, a network node, a communication node, or a wireless node, may be a base station (e.g., any base station described herein), a UE (e.g., any UE described herein), a network controller, an apparatus, a device, a computing system, one or more components, and/or another suitable processing entity configured to perform any of the techniques described herein. For example, a network node may be a UE. As another example, a network node may be a base station. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a first one or more components, a first processing entity, or the like.

A BWP switch for a serving cell may be used to activate an inactive BWP and deactivate an active BWP at once. The BWP switch may be initiated in a number of ways. For example, the BWP switch may be initiated based on a PDCCH transmission (e.g., a DCI message) indicating a downlink assignment or an uplink grant. In another example, the BWP switch may be initiated based on a timer associated with the parameter “bwp-InactivityTimer.” In another example, the BWP switch may be initiated based on RRC signaling. In a further example, the BWP switch may be initiated by the MAC entity upon initiation of a random access procedure.

The PDCCH DCI message based BWP switch may be used to switch the BWP quickly, and may be deployed by operators for the purpose of saving UE power. However, because it is based on a PDCCH grant, the DCI message based BWP switch may be less than robust. For example, the UE may fail to decode the PDCCH due to a poor channel condition. In another example, a UE operating in a multi-SIM (MSIM) mode may occasionally tune away to a second network, and may experience uplink outage associated with a first network during a tune away period. A tune away period or event may be a period of time or procedure during which the UE is not capable of receiving transmissions from the first network. Unlike measurement gaps in which UE informs the first network that it is not available, UE may not inform the first network of the tune away. Therefore, the first network may be unaware of the tune away, and uplink outage associated with a first network may occur as a result. After transmitting a DCI message based BWP switch command, the network may monitor the uplink status. If the UE experiences a high PUSCH BLER, or experiences uplink outage due to the MSIM tune away, the network may fail to detect uplink transmissions from the UE, and the BWP switch may fail. A BWP mismatch may happen when the UE has switched to a new BWP, but the base station has not switched to the same new BWP, or when the base station has switched to a new BWP, but the UE has not switched to the same new BWP. If a BWP mismatch takes place (e.g., due to a missed detection of a PDCCH transmission), the UE may fall back to the default downlink BWP upon the expiration of the “bwp-Inactivity Timer” timer.

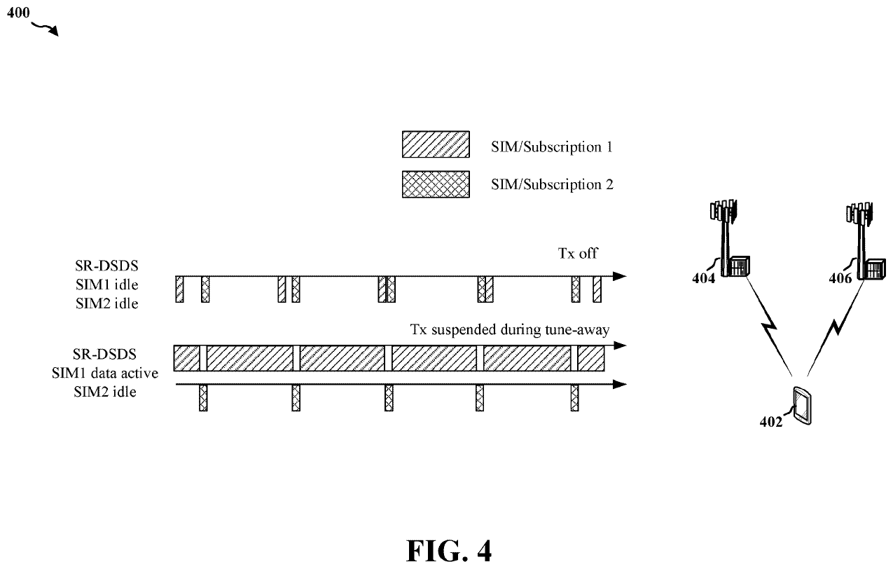

FIG. 4 is a diagram 400 illustrating the operation of a UE in an MSIM mode. The UE 402 may operate in the MSIM mode, in particular, a single receiver (SR)—dual SIM dual standby (DSDS) (SR-DSDS) mode. In other words, the UE 402 may be equipped with two SIMs corresponding to two subscriptions. The two subscriptions may share the same set of hardware, RF, and/or baseband resources. The two subscriptions may be associated with the two base stations 404, 406, respectively. One of the subscriptions may be suspended when the other subscription is active. When both subscriptions are idle, the UE 402 may wake up from time to time in order to monitor for pages or other indications of incoming messages or data, measure signal strengths. and/or receive various control channel information. The UE 402 may perform these monitoring operations for one of the subscriptions each time it wakes up. Accordingly, the two subscriptions may correspond to resource usage in different wake up periods. For example, the UE 402 may alternately wake up for one subscription, then for the other subscription, and so on.

When one subscription (e.g., subscription 1, which may be a data subscription) is active, and the other subscription (e.g., subscription 2) is idle, the UE 402 may, during active data transmission associated with the active subscription, occasionally or periodically tune away to the network associated with the idle subscription in order to perform the monitoring operations in connection with the idle subscription. During the tune away periods, the transmission associated with the active subscription may be suspended. Therefore, for the active subscription, a BWP mismatch may occur if one or more tune away events take place at the UE 402 soon after a PDCCH DCI message based BWP switch is executed.

As described above, if a BWP mismatch takes place, the UE may fall back to the default downlink BWP upon the expiration of the “bwp-Inactivity Timer” timer. If the value of the parameter “bwp-Inactivity Timer” is large, it may take a long time for the UE to resynchronize with the network on the default BWP. If the value of the parameter “bwp-InactivityTimer” is set to infinity, the UE may remain on the mismatched BWP and be out of synchronization with the network until a recovery procedure for a radio link failure (RLF) is performed. For voice over NR (VoNR), the UE may switch to a narrow BWP for a voice call. If a BWP switch failure occurs during a VoNR call, the user may experience a call drop if a quick recovery from the BWP switch failure is not performed.

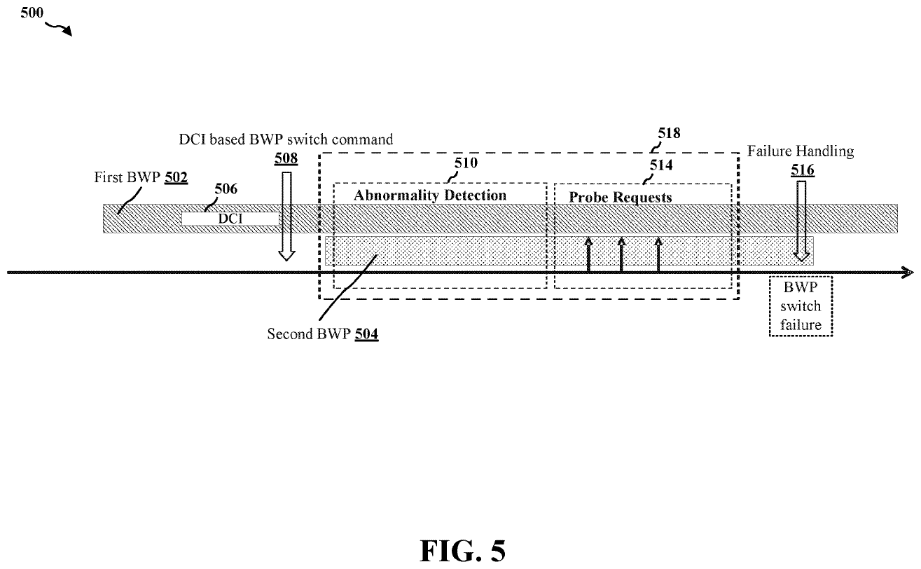

FIG. 5 is a diagram 500 illustrating BWP switch failure detection and handling according to aspects of the disclosure. A first network node (e.g., the UE 104/350/402/702; the apparatus 1002) may receive DCI 506. The first network node may switch from a first BWP 502 to a second BWP 504 based on the DCI 506. For example, the DCI 506 may include information indicative to perform BWP switching. The information may include a BWP switch command 508. Subsequent to or otherwise after the BWP switch, the first network node may perform abnormality detection. The abnormality detection may be performed during a window 510. The window 510 may be or may include a period of time during which the first network node may perform operations in order to detect any BWP switch related abnormality. The window 510 may be referred to as an abnormality detection window 510. In some examples, the first network node may determine the duration of the window 510. For example, the first network node may use any time period to perform abnormality detection. Otherwise described, the length of the window 510 may be determined by the first network node. In some examples, the length of the window 510 may be a default length of time. In some examples, the first network node may receive information from a second network node (e.g., a base station). In such examples, the first network node may determine the duration of the window 510 based on the information received from the second network node. The information may, in some examples, be received in a control channel, such as a PDSCH or a PSCCH. In other examples, the information may be received in RRC signaling, MAC—control element (CE) (MAC-CE) signaling, or any other signaling. In one example, the duration of the window 510 may be approximately 40 ms.

The first network node may perform a BWP switch failure detection procedure 518 to determine whether the BWP switch was successful. In particular, to perform the BWP switch failure detection procedure 518, the first network node may determine whether one or more failure conditions are satisfied (e.g., determine whether one or more failure conditions have occurred). In different examples, the one or more failure conditions may include at least one of a block error rate (BLER) greater than a threshold (e.g., during the abnormality detection window 510), occurrence of one or more tune away events (e.g., full tune away events such as long tune away events, or partial tune away events such as diversity tune away events) (e.g., during the abnormality detection window 510), or non-receipt of an uplink grant on the second BWP 504 based on one or more probe requests. In particular, the BLER may be associated with an uplink channel on which the first network node may be configured to communicate with the second network node. Accordingly, the first network node may determine that the BWP switch was not successful when the BLER is greater than the threshold (e.g., during the abnormality detection window 510), when one or more tune away events have occurred (e.g., during the abnormality detection window 510), or when an uplink grant is not received on the second BWP 504 based on one or more probe requests. Based on determining that the BWP switch was not successful, the first network node may proceed to perform a BWP switch failure handling procedure 516. On the other hand, based on determining that the BWP switch was successful, the first network node may not perform a first RACH procedure on the first BWP, a second RACH procedure on the second BWP, or an RLF recovery procedure. For example, based on determining that the BWP switch was successful, the first network node may refrain from performing a first RACH procedure on the first BWP, a second RACH procedure on the second BWP, or an RLF recovery procedure.

In some configurations, the first network node may perform the uplink grant based detection after identifying a BLER greater than the threshold or the occurrence of one or more tune away events during the abnormality detection window 510. In such configurations, the first network node may confirm the BWP switch failure based on the non-receipt of any uplink grant on the second BWP 504 based on one or more probe requests.

In particular, to perform the uplink grant based detection, the first network node may transmit, to the second network node, one or more probe requests 514. In some examples, the one or more probe requests 514 may include one probe request, two probe requests, or n probe requests, where n is an integer greater than 0. The first network node may select the number of probe requests 514 to transmit to achieve an appropriate balance between the time associated with transmitting the probe requests and the reliability of the result of the probing procedure. A probe request 514 may take the format of a scheduling request (SR), although the first network node may not have data to transmit on the uplink. The probe request 514 may be interpreted by the second network node as an SR. If the first network node and the second network node are on the same BWP and are in synchronization, the second network node may transmit, to the first network node, an uplink grant based on the SR. The first network node may receive the uplink grant accordingly. Therefore, subsequent to transmitting the probe requests 514, the first network node may identify whether at least one uplink grant is received on the second BWP 504 from the second network node based on the one or more probe requests 514.

If at least one uplink grant is received on the second BWP 504 based on the one or more probe requests 514, the first network node may identify that the BWP switch was successful. On the other hand, if no uplink grant is received on the second BWP based on the one or more probe requests, the first network node may identify that the BWP switch was not successful, and may proceed to perform the BWP switch failure handling procedure 516.

During the failure handling procedure 516, the first network node may switch back from the second BWP 504 to the first BWP 502, perform a random access channel (RACH) procedure on the second BWP 504 or the first BWP 502, or perform an RLF recovery procedure. In particular, the first network node may switch back from the second BWP 504 to the first BWP 502 if the first BWP 502 and the second BWP 504 are associated with a same RACH search space and no tune away events associated with a duration longer than a second threshold have occurred. The first network node may select a second threshold such that if the BWP switch failure is associated with a short tune away period (e.g., a few ms to tens of ms), the first network node may first try to handle the failure by switching back from the second BWP 504 to the first BWP 502, but if the BWP switch failure is associated with a long tune away period (e.g., hundreds of ms to one or more seconds), the first network node may handle the failure by performing the RLF recovery procedure, as will be described below. In some examples, after switching back to the first BWP 502, the first network node may perform a RACH procedure on the first BWP 502 in order to regain synchronization with the second network node.

In one aspect, to handle the BWP switch failure, the first network node may perform a RACH procedure on the second BWP 504. In some examples, the first network node may perform a RACH procedure on the second BWP 504 when the first BWP 502 and the second BWP 504 are associated with different RACH search spaces. The RACH procedure may not help the first network node and the second network node regain BWP synchronization when the first BWP 502 and the second BWP 504 are associated with the same RACH search space because the second network node would be unable to identify the BWP in use by the first network node based on the RACH procedure. However, if the first BWP 502 and the second BWP 504 are associated with different RACH search spaces, the RACH procedure may be used to help the first network node and the second network node regain BWP synchronization because the second network node would be able to identify the BWP in use by the first network node based on the RACH procedure. In some examples, if the RACH procedure on the second BWP 504 cannot be completed successfully, the first network node may switch back from the second BWP 504 to the first BWP 502, and perform a RACH procedure on the first BWP 502, if the first BWP 502 and the second BWP 504 are associated with different RACH search spaces.

In a further aspect, to handle the BWP switch failure, the first network node may perform an RLF recovery procedure if one or more tune away events associated with a duration longer than a second threshold have occurred, or if the RACH procedure cannot be completed successfully (e.g., if the first network node cannot receive the expected RACH response messages from the second network node). In some examples, the first network node may perform the RLF recovery procedure after a RACH procedure is performed on the first BWP 502 but cannot be completed successfully, and/or after a RACH procedure is performed on the second BWP 504 but cannot be completed successfully. In some examples, to handle the BWP switch failure, the first network node may perform the RLF recovery procedure without performing any RACH procedure on the first BWP 502 or the second BWP 504 first.

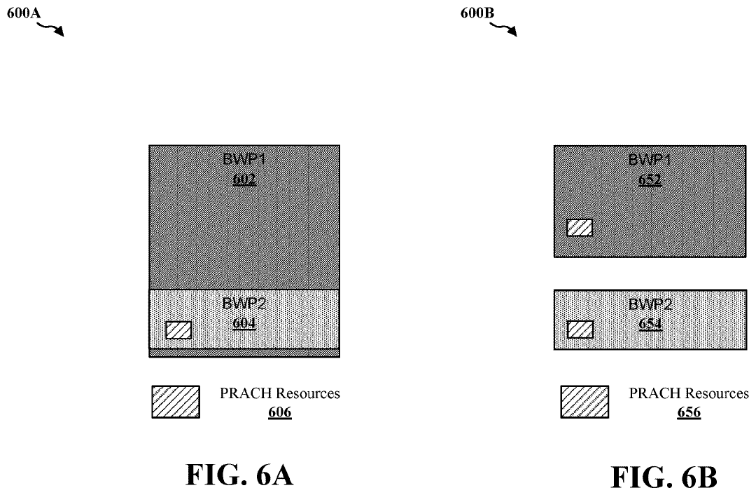

FIGS. 6A and 6B are a diagrams 600A and 600B illustrating RACH search spaces associated with the first and the second BWPs. In FIG. 6A, the first BWP 602 and the second BWP 604 may be configured with the same RACH search space (which may correspond to a set of physical random access channel (PRACH) resources 606). Accordingly, in this example, a RACH procedure may not help the UE and the base station regain BWP synchronization because the base station would be unable to identify which BWP is in use by the UE based on the RACH procedure. In FIG. 6B, the first BWP 652 and the second BWP 654 may be configured with different and separate RACH search spaces (which may correspond to separate sets of PRACH resources 656). Accordingly, in this example, a RACH procedure may be used to help the UE and the base station regain BWP synchronization because the base station may be able to identify the BWP in use by the UE based on the RACH procedure.

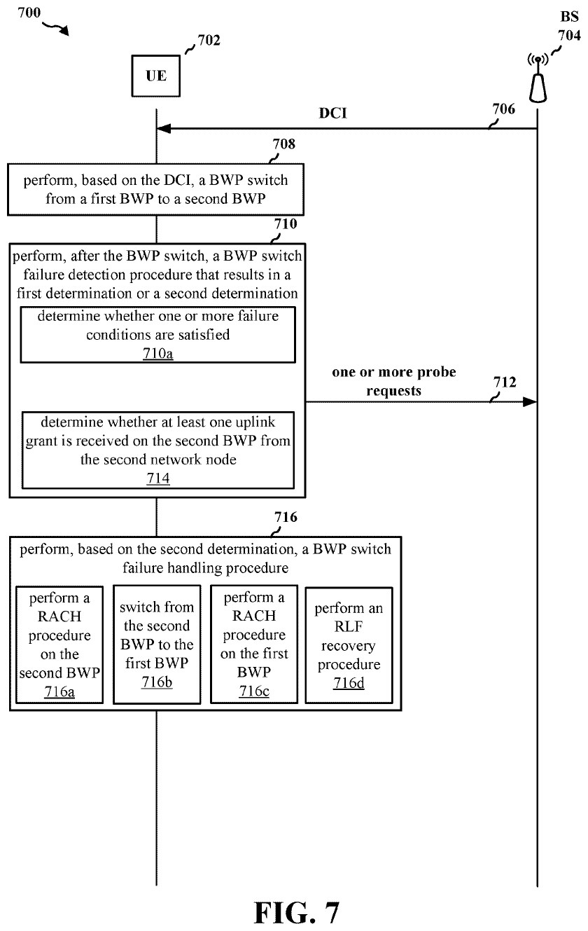

FIG. 7 is a diagram of a communication flow 700 of a method of wireless communication. The UE 702 may also be referred to as the first network node 702. The base station 704 may also be referred to as the second network node 704. At 706, the first network node 702 may receive, from a second network node 704, DCI.

At 708, the first network node 702 may perform, based on the DCI, a BWP switch from a first BWP to a second BWP.

At 710, the first network node 702 may perform, after the BWP switch, a BWP switch failure detection procedure that results in a first determination or a second determination. The first determination may be indicative that the BWP switch was successful and the second determination may be indicative that the BWP switch was not successful.

In particular, at 710a, to determine whether the one or more failure conditions are satisfied, the first network node 702 may determine whether the one or more failure conditions are satisfied within, for example, a detection window. The one or more failure conditions may include at least one of a BLER greater than a threshold, occurrence of one or more tune away events (e.g., a partial tune away event or a full tune away event), or non-receipt of an uplink grant on the second BWP. In particular, the BLER may be associated with an uplink channel (e.g., a PUSCH or a PSSCH) on which the first network node 702 is configured to communicate with the second network node 704. The BWP switch failure detection procedure may result in the first determination based on non-occurrence of the one or more failure conditions, and may result in the second determination based on the occurrence of the one or more failure conditions.

In one configuration, to perform the BWP switch failure detection procedure, at 712, the first network node 702 may transmit, to the second network node 704, one or more probe requests (e.g., SRs) after a determination that the one or more failure conditions are satisfied within the detection window.

At 714, the first network node 702 may determine whether at least one uplink grant is received on the second BWP from the second network node 704. The BWP switch failure detection procedure may result in the first determination when the at least one uplink grant is received on the second BWP, and may result in the second determination when no uplink grant is received on the second BWP.

At 716, the first network node 702 may perform, based on the second determination, a BWP switch failure handling procedure. In particular, in one configuration, at 716a, the first network node 702 may perform a RACH procedure on the second BWP. In one configuration, the RACH procedure on the second BWP may be performed when the first BWP and the second BWP are associated with different RACH search spaces. In one configuration, the RACH procedure on the second BWP may be performed when the first BWP and the second BWP are associated with a same RACH search space.

In one configuration, at 716b, the first network node 702 may switch from the second BWP to the first BWP. At 716c, the first network node 702 may perform a RACH procedure on the first BWP. In one configuration, the switch from the second BWP to the first BWP may be performed when the first BWP and the second BWP are associated with different RACH search spaces and no tune away events associated with a duration longer than a second threshold have occurred.

In one configuration, at 716d, the first network node 702 may perform an RLF recovery procedure. In one configuration, the RLF recovery procedure may be performed after a first RACH procedure is performed on the first BWP and/or after a second RACH procedure is performed on the second BWP. In one configuration, the RLF recovery procedure may be performed when at least one tune away event of the one or more tune away events is associated with a duration longer than a second threshold. In one configuration, the RLF recovery procedure may be performed when the RACH procedure on the first BWP or the second BWP cannot be completed successfully.

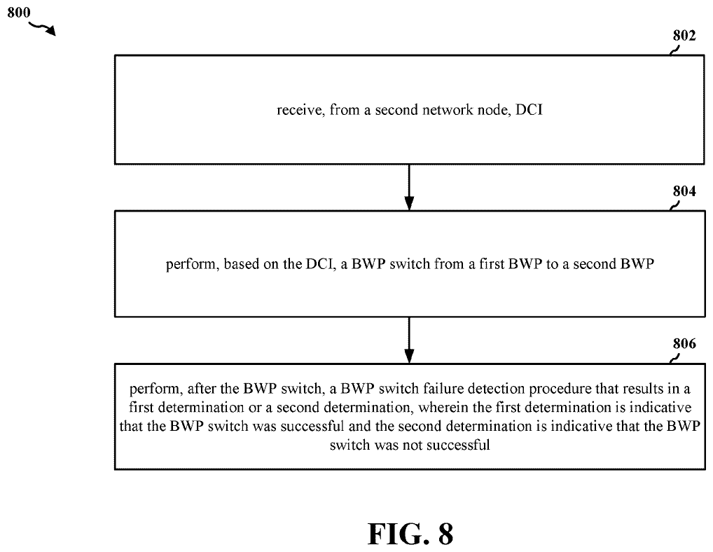

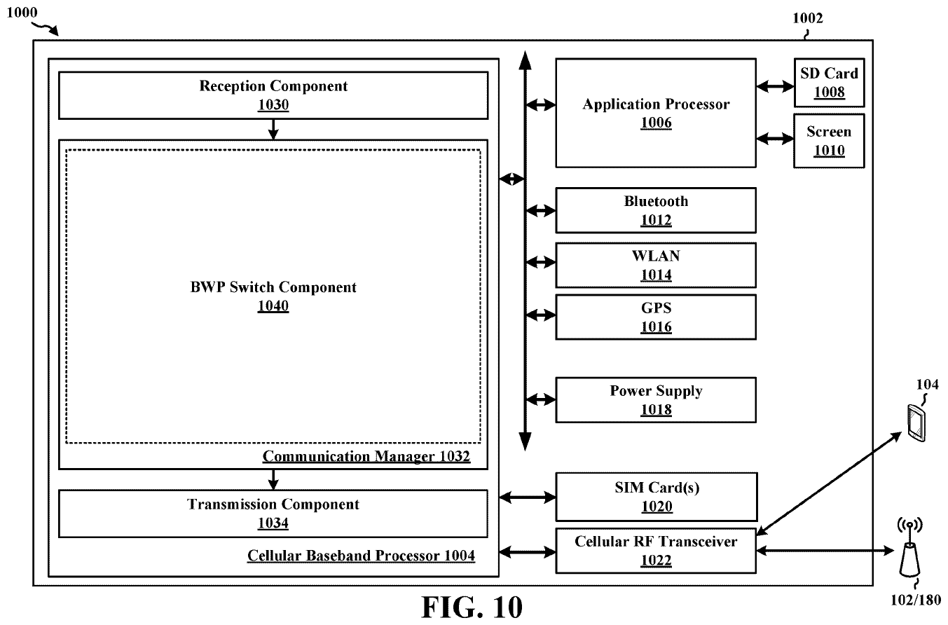

FIG. 8 is a flowchart 800 of a method of wireless communication. The method may be performed by a first network node (e.g., the UE 104/350/402/702; the apparatus 1002). At 802, the first network node may receive, from a second network node, DCI. For example, 802 may be performed by the BWP switch component 1040 in FIG. 10. Referring to FIG. 7, at 706, the first network node 702 may receive, from a second network node 704, DCI.

At 804, the first network node may perform, based on the DCI, a BWP switch from a first BWP to a second BWP. For example, 804 may be performed by the BWP switch component 1040 in FIG. 10. Referring to FIG. 7, at 708, the first network node 702 may perform, based on the DCI, a BWP switch from a first BWP to a second BWP.

At 806, the first network node may perform, after the BWP switch, a BWP switch failure detection procedure that results in a first determination or a second determination. The first determination may be indicative that the BWP switch was successful and the second determination may be indicative that the BWP switch was not successful. For example, 806 may be performed by the BWP switch component 1040 in FIG. 10. Referring to FIG. 7, at 710, the first network node 702 may perform, after the BWP switch, a BWP switch failure detection procedure that results in a first determination or a second determination.

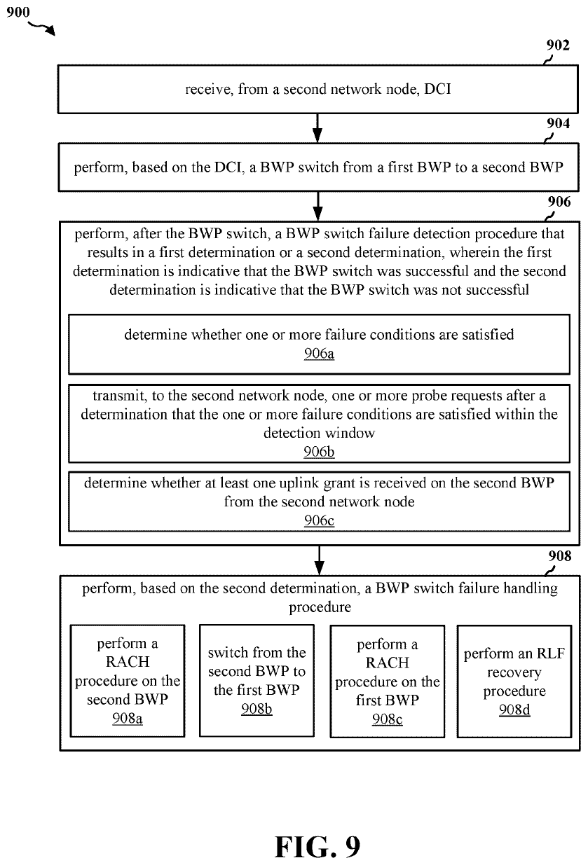

FIG. 9 is a flowchart 900 of a method of wireless communication. The method may be performed by a first network node (e.g., the UE 104/350/702; the apparatus 1002). At 902, the first network node may receive, from a second network node, DCI. For example, 902 may be performed by the BWP switch component 1040 in FIG. 10. Referring to FIG. 7, at 706, the first network node 702 may receive, from a second network node 704, DCI.

At 904, the first network node may perform, based on the DCI, a BWP switch from a first BWP to a second BWP. For example, 904 may be performed by the BWP switch component 1040 in FIG. 10. Referring to FIG. 7, at 708, the first network node 702 may perform, based on the DCI, a BWP switch from a first BWP to a second BWP.

At 906, the first network node may perform, after the BWP switch, a BWP switch failure detection procedure that results in a first determination or a second determination. The first determination may be indicative that the BWP switch was successful and the second determination may be indicative that the BWP switch was not successful. For example, 906 may be performed by the BWP switch component 1040 in FIG. 10. Referring to FIG. 7, at 710, the first network node 702 may perform, after the BWP switch, a BWP switch failure detection procedure that results in a first determination or a second determination.

In one configuration, at 906a, to perform the BWP switch failure detection procedure, the first network node may determine whether one or more failure conditions are satisfied. For example, 906a may be performed by the BWP switch component 1040 in FIG. 10. Referring to FIG. 7, at 710a, to perform the BWP switch failure detection procedure, the first network node 702 may determine whether one or more failure conditions are satisfied.

In one configuration, the one or more failure conditions may include at least one of: a BLER greater than a threshold, where the BLER may be associated with an uplink channel on which the first network node is configured to communicate with the second network node; occurrence of one or more tune away events; or non-receipt of an uplink grant on the second BWP.

In one configuration, the uplink channel may include a PUSCH or a PSSCH. In examples where the uplink channel includes a PSSCH, it is understood that PSSCH may be considered an uplink channel from the perspective of a first network node that transmits to a second network node on a PSSCH.

In one configuration, the one or more tune away events may include a partial tune away event or a full tune away event.

In one configuration, the BWP switch failure detection procedure may result in the first determination based on non-occurrence of the one or more failure conditions.

In one configuration, referring to FIG. 7, based on the first determination, the first network node 702 may not perform at least one of: a first RACH procedure on the first BWP; a second RACH procedure on the second BWP; or an RLF recovery procedure.

In one configuration, the BWP switch failure detection procedure may result in the second determination based on the occurrence of the one or more failure conditions.

In one configuration, referring to FIG. 7, based on the second determination, the first network node 702 may perform at least one of: a first RACH procedure on the first BWP; a second RACH procedure on the second BWP; or an RLF recovery procedure.

In one configuration, at 906a, to determine the one or more failure conditions are satisfied, the first network node may determine whether the one or more failure conditions are satisfied within a detection window. For example, 906a may be performed by the BWP switch component 1040 in FIG. 10. Referring to FIG. 7, at 710a, to determine the one or more failure conditions are satisfied, the first network node 702 may determine whether the one or more failure conditions are satisfied within a detection window.

In one configuration, the one or more failure conditions may include at least one of: a BLER greater than a threshold, where the BLER may be associated with an uplink channel on which the first network node is configured to communicate with the second network node; occurrence of one or more tune away events; or non-receipt of an uplink grant on the second BWP.

In one configuration, the BWP switch failure detection procedure may result in the first determination based on non-occurrence of the one or more failure conditions.

In one configuration, to perform the BWP switch failure detection procedure, at 906b, the first network node may transmit, to the second network node, one or more probe requests after a determination that the one or more failure conditions are satisfied within the detection window. For example, 906b may be performed by the BWP switch component 1040 in FIG. 10. Referring to FIG. 7, at 712, the first network node 702 may transmit, to the second network node 704, one or more probe requests after a determination that the one or more failure conditions are satisfied within the detection window. At 906c, the first network node may determine whether at least one uplink grant is received on the second BWP from the second network node. For example, 906c may be performed by the BWP switch component 1040 in FIG. 10. Referring to FIG. 7, at 714, the first network node 702 may determine whether at least one uplink grant is received on the second BWP from the second network node 704.

In one configuration, the one or more probe requests may be one or more SRs.

In one configuration, the BWP switch failure detection procedure may result in the first determination when the at least one uplink grant is received on the second BWP.

In one configuration, the BWP switch failure detection procedure may result in the second determination when no uplink grant is received on the second BWP.

In one configuration, at 908, the first network node may perform, based on the second determination, a BWP switch failure handling procedure. For example, 908 may be performed by the BWP switch component 1040 in FIG. 10. Referring to FIG. 7, at 716, the first network node 702 may perform, based on the second determination, a BWP switch failure handling procedure.

In one configuration, at 908a, to perform the BWP switch failure handling procedure, the first network node may perform a RACH procedure on the second BWP. For example, 908a may be performed by the BWP switch component 1040 in FIG. 10. Referring to FIG. 7, at 716a, to perform the BWP switch failure handling procedure, the first network node 702 may perform a RACH procedure on the second BWP.

In one configuration, to perform the BWP switch failure handling procedure, at 908b, the first network node may switch from the second BWP to the first BWP. For example, 908b may be performed by the BWP switch component 1040 in FIG. 10. Referring to FIG. 7, at 716b, the first network node 702 may switch from the second BWP to the first BWP. At 908c, the first network node may perform a RACH procedure on the first BWP. For example, 908c may be performed by the BWP switch component 1040 in FIG. 10. Referring to FIG. 7, at 716c, the first network node 702 may perform a RACH procedure on the first BWP.

In one configuration, at 908d, to perform the BWP switch failure handling procedure, the first network node may perform an RLF recovery procedure. For example, 908d may be performed by the BWP switch component 1040 in FIG. 10. Referring to FIG. 7, at 716d, to perform the BWP switch failure handling procedure, the first network node 702 may perform an RLF recovery procedure.

In one configuration, referring to FIG. 7, to perform the RLF recovery procedure, the first network node 702 may perform the RLF recovery procedure after at least one of: a first RACH procedure is performed on the first BWP; or a second RACH procedure is performed on the second BWP.

In one configuration, the BWP switch failure handling procedure may include at least one of: a first RACH procedure on the first BWP; a second RACH procedure on the second BWP; or an RLF recovery procedure.

In one configuration, the BWP switch failure handling procedure may include at least one of a switch from the second BWP to the first BWP, a RACH procedure on the second BWP, or an RLF recovery procedure.

In one configuration, the switch from the second BWP to the first BWP may be performed when the first BWP and the second BWP are associated with different RACH search spaces and no tune away events associated with a duration longer than a second threshold have occurred.

In one configuration, the RACH procedure on the second BWP may be performed when the first BWP and the second BWP are associated with different RACH search spaces or a same RACH search space.

In one configuration, the RLF recovery procedure may be performed when: at least one tune away event of the one or more tune away events is associated with a duration longer than a second threshold; or the RACH procedure on the second BWP cannot be completed successfully.

FIG. 10 is a diagram 1000 illustrating an example of a hardware implementation for an apparatus 1002. The apparatus 1002 may be a first network node, a UE, a component of a UE, or may implement UE functionality. In some aspects, the apparatus 1002 may include a cellular baseband processor 1004 (also referred to as a modem) coupled to a cellular RF transceiver 1022. In some aspects, the apparatus 1002 may further include one or more subscriber identity modules (SIM) cards 1020, an application processor 1006 coupled to a secure digital (SD) card 1008 and a screen 1010, a Bluetooth module 1012, a wireless local area network (WLAN) module 1014, a Global Positioning System (GPS) module 1016, or a power supply 1018. The cellular baseband processor 1004 communicates through the cellular RF transceiver 1022 with the UE 104 and/or BS 102/180. The cellular baseband processor 1004 may include a computer-readable medium/memory. The computer-readable medium/memory may be non-transitory. The cellular baseband processor 1004 is responsible for general processing, including the execution of software stored on the computer-readable medium/memory. The software, when executed by the cellular baseband processor 1004, causes the cellular baseband processor 1004 to perform the various functions described supra. The computer-readable medium/memory may also be used for storing data that is manipulated by the cellular baseband processor 1004 when executing software. The cellular baseband processor 1004 further includes a reception component 1030, a communication manager 1032, and a transmission component 1034. The communication manager 1032 includes the one or more illustrated components. The components within the communication manager 1032 may be stored in the computer-readable medium/memory and/or configured as hardware within the cellular baseband processor 1004. The cellular baseband processor 1004 may be a component of the UE 350 and may include the memory 360 and/or at least one of the TX processor 368, the RX processor 356, and the controller/processor 359. In one configuration, the apparatus 1002 may be a modem chip and include just the baseband processor 1004, and in another configuration, the apparatus 1002 may be the entire UE (e.g., see 350) of FIG. 3) and include the additional modules of the apparatus 1002.

The communication manager 1032 includes a BWP switch component 1040 that may be configured to receive, from a second network node, DCI, e.g., as described in connection with 802 in FIGS. 8 and 902 in FIG. 9. The BWP switch component 1040) may be configured to perform, based on the DCI, a BWP switch from a first BWP to a second BWP, e.g., as described in connection with 804 in FIG. 8 and 904 in FIG. 9. The BWP switch component 1040 may be configured to perform, after the BWP switch, a BWP switch failure detection procedure that results in a first determination or a second determination, e.g., as described in connection with 806 in FIG. 8 and 906 in FIG. 9. The BWP switch component 1040 may be configured to determine whether one or more failure conditions are satisfied, e.g., as described in connection with 906a in FIG. 9. The BWP switch component 1040 may be configured to transmit, to the second network node, one or more probe requests after a determination that the one or more failure conditions are satisfied within the detection window, e.g., as described in connection with 906b in FIG. 9. The BWP switch component 1040 may be configured to determine whether at least one uplink grant is received on the second BWP from the second network node, e.g., as described in connection with 906c in FIG. 9. The BWP switch component 1040 may be configured to perform, based on the second determination, a BWP switch failure handling procedure, e.g., as described in connection with 908 in FIG. 9. The BWP switch component 1040 may be configured to perform a RACH procedure on the second BWP, e.g., as described in connection with 908a in FIG. 9. The BWP switch component 1040 may be configured to switch from the second BWP to the first BWP, e.g., as described in connection with 908b in FIG. 9. The BWP switch component 1040 may be configured to perform a RACH procedure on the first BWP, e.g., as described in connection with 908c in FIG. 9. The BWP switch component 1040 may be configured to perform an RLF recovery procedure, e.g., as described in connection with 908d in FIG. 9.

The apparatus may include additional components that perform each of the blocks of the algorithm in the flowcharts of FIGS. 7-9. As such, each block in the flowcharts of FIGS. 7-9 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1002 may include a variety of components configured for various functions. In one configuration, the apparatus 1002, and in particular the cellular baseband processor 1004, includes means for receiving, from a second network node, DCI. The apparatus 1002, and in particular the cellular baseband processor 1004, includes means for performing, based on the DCI, a BWP switch from a first BWP to a second BWP. The apparatus 1002, and in particular the cellular baseband processor 1004, includes means for performing, after the BWP switch, a BWP switch failure detection procedure that results in a first determination or a second determination. The first determination may be indicative that the BWP switch was successful and the second determination may be indicative that the BWP switch was not successful.

In one configuration, the means for performing the BWP switch failure detection procedure may be further configured to determine whether one or more failure conditions are satisfied. In one configuration, the one or more failure conditions may include at least one of: a BLER greater than a threshold, where the BLER may be associated with an uplink channel on which the first network node is configured to communicate with the second network node; occurrence of one or more tune away events; or non-receipt of an uplink grant on the second BWP. In one configuration, the uplink channel may include a PUSCH or a PSSCH. In examples where the uplink channel includes a PSSCH, it is understood that PSSCH may be considered an uplink channel from the perspective of a first network node that transmits to a second network node on a PSSCH. In one configuration, the one or more tune away events may include a partial tune away event or a full tune away event. In one configuration, the BWP switch failure detection procedure may result in the first determination based on non-occurrence of the one or more failure conditions. In one configuration, based on the first determination, the apparatus 1002, and in particular the cellular baseband processor 1004, may not include means for performing at least one of: a first RACH procedure on the first BWP; a second RACH procedure on the second BWP; or an RLF recovery procedure. In one configuration, the BWP switch failure detection procedure may result in the second determination based on the occurrence of the one or more failure conditions. In one configuration, based on the second determination, the apparatus 1002, and in particular the cellular baseband processor 1004, includes means for performing at least one of: a first RACH procedure on the first BWP; a second RACH procedure on the second BWP; or an RLF recovery procedure. In one configuration, to determine the one or more failure conditions are satisfied, the first network node may determine whether the one or more failure conditions are satisfied within a detection window. In one configuration, the one or more failure conditions may include at least one of: a BLER greater than a threshold, where the BLER may be associated with an uplink channel on which the first network node is configured to communicate with the second network node; occurrence of one or more tune away events; or non-receipt of an uplink grant on the second BWP. In one configuration, the BWP switch failure detection procedure may result in the first determination based on non-occurrence of the one or more failure conditions. In one configuration, the means for performing the BWP switch failure detection procedure may be further configured to transmit, to the second network node, one or more probe requests after a determination that the one or more failure conditions are satisfied within the detection window; and determine whether at least one uplink grant is received on the second BWP from the second network node. In one configuration, the one or more probe requests may be one or more SRs. In one configuration, the BWP switch failure detection procedure may result in the first determination when the at least one uplink grant is received on the second BWP. In one configuration, the BWP switch failure detection procedure may result in the second determination when no uplink grant is received on the second BWP. In one configuration, the apparatus 1002, and in particular the cellular baseband processor 1004, includes means for performing, based on the second determination, a BWP switch failure handling procedure. In one configuration, the means for performing the BWP switch failure handling procedure may be further configured to perform a RACH procedure on the second BWP. In one configuration, the means for performing the BWP switch failure handling procedure may be further configured to switch from the second BWP to the first BWP; and perform a RACH procedure on the first BWP. In one configuration, the means for performing the BWP switch failure handling procedure may be further configured to perform an RLF recovery procedure. In one configuration, to perform the RLF recovery procedure, the first network node may perform the RLF recovery procedure after at least one of: a first RACH procedure is performed on the first BWP; or a second RACH procedure is performed on the second BWP. In one configuration, the BWP switch failure handling procedure may include at least one of: a first RACH procedure on the first BWP; a second RACH procedure on the second BWP; or an RLF recovery procedure. In one configuration, the BWP switch failure handling procedure may include at least one of a switch from the second BWP to the first BWP, a RACH procedure on the second BWP, or an RLF recovery procedure. In one configuration, the switch from the second BWP to the first BWP may be performed when the first BWP and the second BWP are associated with different RACH search spaces and no tune away events associated with a duration longer than a second threshold have occurred. In one configuration, the RACH procedure on the second BWP may be performed when the first BWP and the second BWP are associated with different RACH search spaces or a same RACH search space. In one configuration, the RLF recovery procedure may be performed when: at least one tune away event of the one or more tune away events is associated with a duration longer than a second threshold; or the RACH procedure on the second BWP cannot be completed successfully.

The means may be one or more of the components of the apparatus 1002 configured to perform the functions recited by the means. As described supra, the apparatus 1002 may include the TX Processor 368, the RX Processor 356, and the controller/processor 359. As such, in one configuration, the means may be the TX Processor 368, the RX Processor 356, and the controller/processor 359 configured to perform the functions recited by the means.

Referring back to FIGS. 4-9, a first network node (e.g., a UE) may receive, from a second network node (e.g., a base station), DCI. The first network node may perform, based on the DCI, a BWP switch from a first BWP to a second BWP. The first network node may perform, after the BWP switch, a BWP switch failure detection procedure that results in a first determination or a second determination. The first determination may be indicative that the BWP switch was successful and the second determination may be indicative that the BWP switch was not successful. Accordingly, the UE may be resynchronized with the base station quickly in case of a BWP switch failure, so that the disrupted data traffic may be promptly resumed, and potential call drops avoided.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication at a UE including at least one processor coupled to a memory and configured to receive, from a base station, a BWP switch command in a DCI message; perform a BWP switch from a first BWP to a second BWP based on the BWP switch command; and identify whether the BWP switch is successful based on at least one of one or more tune away events, a BLER associated with one or more PUSCHs, or one or more probe requests.

Aspect 2 is the apparatus of aspect 1, the at least one processor being further configured to: detect, within a detection window following the BWP switch, whether the one or more tune away events have occurred; and identify, within the detection window; the BLER associated with the one or more PUSCHs.

Aspect 3 is the apparatus of aspect 2, where to identify whether the BWP switch is successful, the at least one processor is further configured to: identify that the BWP switch is successful when no tune away events have occurred within the detection window and the BLER within the detection window is less than a first threshold.

Aspect 4 is the apparatus of aspect 2, the at least one processor being further configured to: transmit, to the base station, the one or more probe requests in response to detecting that the one or more tune away events have occurred within the detection window or identifying the BLER within the detection window as being greater than a first threshold; and identify whether at least one uplink grant is received on the second BWP from the base station based on the one or more probe requests.

Aspect 5 is the apparatus of aspect 4, where the one or more probe requests correspond to one or more SRs.

Aspect 6 is the apparatus of any of aspects 4 and 5, where to identify whether the BWP switch is successful, the at least one processor is further configured to: identify that the BWP switch is successful when the at least one uplink grant is received on the second BWP based on the one or more probe requests.

Aspect 7 is the apparatus of any of aspects 4 and 5, where to identify whether the BWP switch is successful, the at least one processor is further configured to: identify that the BWP switch is not successful when no uplink grant is received on the second BWP based on the one or more probe requests.

Aspect 8 is the apparatus of aspect 7, the at least one processor being further configured to: perform a failure handling procedure in response to identifying that the BWP switch is not successful.

Aspect 9 is the apparatus of aspect 8, where the failure handling procedure includes at least one of a fallback to the first BWP, a RACH procedure on the second BWP, or an RLF recovery procedure.

Aspect 10 is the apparatus of aspect 9, where the fallback to the first BWP is performed when the first BWP and the second BWP are associated with different RACH search spaces and no tune away events associated with a duration longer than a second threshold have occurred.

Aspect 11 is the apparatus of aspect 9, where the RACH procedure on the second BWP is performed when the first BWP and the second BWP are associated with different RACH search spaces.

Aspect 12 is the apparatus of aspect 9, where the RLF recovery procedure is performed when: at least one tune away event of the one or more tune away events is associated with a duration longer than a second threshold, or the RACH procedure on the second BWP cannot be completed successfully.

Aspect 13 is the apparatus of any of aspects 1 to 12, further comprising a transceiver coupled to the at least one processor.

Aspect 14 is a first network node for wireless communication, including: a memory; and at least one processor communicatively coupled to the memory and configured to: receive, from a second network node, DCI; perform, based on the DCI, a BWP switch from a first BWP to a second BWP; and perform, after the BWP switch, a BWP switch failure detection procedure that results in a first determination or a second determination, where the first determination is indicative that the BWP switch was successful and the second determination is indicative that the BWP switch was not successful.

Aspect 15 is the first network node of aspect 14, where to perform the BWP switch failure detection procedure, the at least one processor is configured to: determine whether one or more failure conditions are satisfied.

Aspect 16 is the first network node of aspect 15, where the one or more failure conditions include at least one of: a BLER greater than a threshold, where the BLER is associated with an uplink channel on which the first network node is configured to communicate with the second network node; occurrence of one or more tune away events; or non-receipt of an uplink grant on the second BWP.

Aspect 17 is the first network node of aspect 16, where the uplink channel includes a PUSCH or a PSSCH.

Aspect 18 is the first network node of any of aspects 16 and 17, where the one or more tune away events include a partial tune away event or a full tune away event.

Aspect 19 is the first network node of any of aspects 16 to 18, where the BWP switch failure detection procedure results in the first determination based on non-occurrence of the one or more failure conditions.

Aspect 20 is the first network node of aspect 19, where, based on the first determination, the at least one processor is configured to not perform at least one of: a first RACH procedure on the first BWP; a second RACH procedure on the second BWP; or an RLF recovery procedure.

Aspect 21 is the first network node of any of aspects 16 to 18, where the BWP switch failure detection procedure results in the second determination based on the occurrence of the one or more failure conditions.

Aspect 22 is the first network node of aspect 21, where, based on the second determination, the at least one processor is configured to perform at least one of: a first RACH procedure on the first BWP; a second RACH procedure on the second BWP; or an RLF recovery procedure.

Aspect 23 is the first network node of any of aspects 15 to 22, where to determine the one or more failure conditions are satisfied, the at least one processor is configured to determine whether the one or more failure conditions are satisfied within a detection window.

Aspect 24 is the first network node of aspect 23, where the one or more failure conditions include at least one of: a BLER greater than a threshold, where the BLER is associated with an uplink channel on which the first network node is configured to communicate with the second network node; occurrence of one or more tune away events; or non-receipt of an uplink grant on the second BWP.

Aspect 25 is the first network node of aspect 24, where the BWP switch failure detection procedure results in the first determination based on non-occurrence of the one or more failure conditions.

Aspect 26 is the first network node of any of aspects 24 and 25, where to perform the BWP switch failure detection procedure, the at least one processor is configured to: transmit, to the second network node, one or more probe requests after a determination that the one or more failure conditions are satisfied within the detection window; and determine whether at least one uplink grant is received on the second BWP from the second network node.

Aspect 27 is the first network node of aspect 26, where the one or more probe requests are one or more SRs.

Aspect 28 is the first network node of any of aspects 26 and 27, where the BWP switch failure detection procedure results in the first determination when the at least one uplink grant is received on the second BWP.

Aspect 29 is the first network node of any of aspects 26 and 27, where the BWP switch failure detection procedure results in the second determination when no uplink grant is received on the second BWP.

Aspect 30 is the first network node of aspect 29, where the at least one processor is configured to: perform, based on the second determination, a BWP switch failure handling procedure.

Aspect 31 is the first network node of aspect 30, where to perform the BWP switch failure handling procedure, the at least one processor is configured to: perform a RACH procedure on the second BWP.

Aspect 32 is the first network node of aspect 30, where to perform the BWP switch failure handling procedure, the at least one processor is configured to: switch from the second BWP to the first BWP; and perform a RACH procedure on the first BWP.

Aspect 33 is the first network node of aspect 30, where to perform the BWP switch failure handling procedure, the at least one processor is configured to: perform an RLF recovery procedure.

Aspect 34 is the first network node of aspect 33, where to perform the RLF recovery procedure, the at least one processor is configured to perform the RLF recovery procedure after at least one of: a first RACH procedure is performed on the first BWP; or a second RACH procedure is performed on the second BWP.

Aspect 35 is the first network node of aspect 30, where the BWP switch failure handling procedure includes at least one of: a first RACH procedure on the first BWP; a second RACH procedure on the second BWP; or an RLF recovery procedure.

Aspect 36 is the first network node of aspect 30, where the BWP switch failure handling procedure includes at least one of a switch from the second BWP to the first BWP, a RACH procedure on the second BWP, or an RLF recovery procedure.

Aspect 37 is the first network node of aspect 36, where the switch from the second BWP to the first BWP is performed when the first BWP and the second BWP are associated with different RACH search spaces and no tune away events associated with a duration longer than a second threshold have occurred.

Aspect 38 is the first network node of aspect 36, where the RACH procedure on the second BWP is performed when the first BWP and the second BWP are associated with different RACH search spaces or a same RACH search space.

Aspect 39 is the first network node of aspect 36, where the RLF recovery procedure is performed when: at least one tune away event of the one or more tune away events is associated with a duration longer than a second threshold; or the RACH procedure on the second BWP cannot be completed successfully.

Aspect 40 is a method of wireless communication for implementing any of aspects 1 to 39.

Aspect 41 is an apparatus for wireless communication including means for implementing any of aspects 1 to 39.

Aspect 42 is a computer-readable medium storing computer executable code. where the code when executed by a processor causes the processor to implement any of aspects 1 to 39.

What is claimed is:

1. A first network node for wireless communication, comprising:
a memory; and
at least one processor communicatively coupled to the memory and configured to:
receive, from a second network node, downlink control information (DCI);
perform, based on the DCI, a bandwidth part (BWP) switch from a first BWP to a second BWP; and
perform, after the BWP switch, a BWP switch failure detection procedure that results in a first determination or a second determination, wherein the first determination is indicative that the BWP switch was successful and the second determination is indicative that the BWP switch was not successful.

2. The first network node of claim 1, wherein to perform the BWP switch failure detection procedure, the at least one processor is configured to:
determine whether one or more failure conditions are satisfied.

3. The first network node of claim 2, wherein the one or more failure conditions include at least one of:
a block error rate (BLER) greater than a threshold, wherein the BLER is associated with an uplink channel on which the first network node is configured to communicate with the second network node;
occurrence of one or more tune away events; or
non-receipt of an uplink grant on the second BWP.

4. The first network node of claim 3, wherein the uplink channel includes a physical uplink shared channel (PUSCH) or a physical sidelink shared channel (PSSCH).

5. The first network node of claim 3, wherein the one or more tune away events include a partial tune away event or a full tune away event.

6. The first network node of claim 3, wherein the BWP switch failure detection procedure results in the first determination based on non-occurrence of the one or more failure conditions.

7. The first network node of claim 6, wherein, based on the first determination, the at least one processor is configured to not perform at least one of:
a first random access channel (RACH) procedure on the first BWP;
a second RACH procedure on the second BWP; or
a radio link failure (RLF) recovery procedure.

8. The first network node of claim 3, wherein the BWP switch failure detection procedure results in the second determination based on the occurrence of the one or more failure conditions.

9. The first network node of claim 8, wherein, based on the second determination, the at least one processor is configured to perform at least one of:
a first random access channel (RACH) procedure on the first BWP;
a second RACH procedure on the second BWP; or
a radio link failure (RLF) recovery procedure.

10. The first network node of claim 2, wherein to determine the one or more failure conditions are satisfied, the at least one processor is configured to determine whether the one or more failure conditions are satisfied within a detection window.

11. The first network node of claim 10, wherein the one or more failure conditions include at least one of:
a block error rate (BLER) greater than a threshold, wherein the BLER is associated with an uplink channel on which the first network node is configured to communicate with the second network node;
occurrence of one or more tune away events; or
non-receipt of an uplink grant on the second BWP.

12. The first network node of claim 11, wherein the BWP switch failure detection procedure results in the first determination based on non-occurrence of the one or more failure conditions.

13. The first network node of claim 11, wherein to perform the BWP switch failure detection procedure, the at least one processor is configured to:
transmit, to the second network node, one or more probe requests after a determination that the one or more failure conditions are satisfied within the detection window; and
determine whether at least one uplink grant is received on the second BWP from the second network node.

14. The first network node of claim 13, wherein the one or more probe requests are one or more scheduling requests (SRs).

15. The first network node of claim 13, wherein the BWP switch failure detection procedure results in the first determination when the at least one uplink grant is received on the second BWP.

16. The first network node of claim 13, wherein the BWP switch failure detection procedure results in the second determination when no uplink grant is received on the second BWP.

17. The first network node of claim 16, wherein the at least one processor is configured to:
perform, based on the second determination, a BWP switch failure handling procedure.

18. The first network node of claim 17, wherein to perform the BWP switch failure handling procedure, the at least one processor is configured to:
perform a random access channel (RACH) procedure on the second BWP.

19. The first network node of claim 17, wherein to perform the BWP switch failure handling procedure, the at least one processor is configured to:
switch from the second BWP to the first BWP; and
perform a random access channel (RACH) procedure on the first BWP.

20. The first network node of claim 17, wherein to perform the BWP switch failure handling procedure, the at least one processor is configured to:
perform a radio link failure (RLF) recovery procedure.

21. The first network node of claim 20, wherein to perform the RLF recovery procedure, the at least one processor is configured to perform the RLF recovery procedure after at least one of:
a first random access channel (RACH) procedure is performed on the first BWP; or
a second RACH procedure is performed on the second BWP.

22. The first network node of claim 17, wherein the BWP switch failure handling procedure comprises at least one of:
a first random access channel (RACH) procedure on the first BWP;
a second RACH procedure on the second BWP; or
a radio link failure (RLF) recovery procedure.

23. The first network node of claim 17, wherein the BWP switch failure handling procedure comprises at least one of a switch from the second BWP to the first BWP, a random access channel (RACH) procedure on the second BWP, or a radio link failure (RLF) recovery procedure.

24. The first network node of claim 23, wherein the switch from the second BWP to the first BWP is performed when the first BWP and the second BWP are associated with different RACH search spaces and no tune away events associated with a duration longer than a second threshold have occurred.

25. The first network node of claim 23, wherein the RACH procedure on the second BWP is performed when the first BWP and the second BWP are associated with different RACH search spaces or a same RACH search space.

26. The first network node of claim 23, wherein the RLF recovery procedure is performed when:
at least one tune away event of the one or more tune away events is associated with a duration longer than a second threshold; or
the RACH procedure on the second BWP cannot be completed successfully.

27. A method of wireless communication performed by a first network node, comprising:
receiving, from a second network node, downlink control information (DCI);
performing, based on the DCI, a bandwidth part (BWP) switch from a first BWP to a second BWP; and
performing, after the BWP switch, a BWP switch failure detection procedure that results in a first determination or a second determination, wherein the first determination is indicative that the BWP switch was successful and the second determination is indicative that the BWP switch was not successful.

28. The method of claim 27, wherein performing the BWP switch failure detection procedure comprises determining whether one or more failure conditions are satisfied.

29. The method of claim 28, wherein the one or more failure conditions include at least one of:
a block error rate (BLER) greater than a threshold, wherein the BLER is associated with an uplink channel on which the first network node is configured to communicate with the second network node;
occurrence of one or more tune away events; or
non-receipt of an uplink grant on the second BWP.

30. A non-transitory computer-readable medium comprising code stored that, when executed by a first network node, causes the first network node to:
receive, from a second network node, downlink control information (DCI);
perform, based on the DCI, a bandwidth part (BWP) switch from a first BWP to a second BWP; and
perform, after the BWP switch, a BWP switch failure detection procedure that results in a first determination or a second determination, wherein the first determination is indicative that the BWP switch was successful and the second determination is indicative that the BWP switch was not successful.
